(19) United States
(12) Patent Application Publication
(10) Pub. No.: US 2012/0018478 A1
(43) Pub. Date: Jan. 26, 2012

(54) QUICK DEPLOYMENT OF STORED EQUIPMENT

(75) Inventors: Robert J. Hanna, San Diego, CA (US); Jonathan M. Gumbert, La Mesa, CA (US); Daniel C. Stein, Cos Cob, CT (US); Miguel T. Sotello, San Diego, CA (US)

(73) Assignee: PHOKUS RESEARCH GROUP, LLC, Rye, NY (US)

(21) Appl. No.: 13/145,940

(22) PCT Filed: Jan. 25, 2010
(86) PCT No.: PCT/US10/22003

§ 371 Date: Oct. 5, 2011

Related U.S. Application Data
(63) Continuation-in-part of application No. 12/359,308, filed on Jan. 24, 2009.

(51) Int. Cl. A45F 3/04; B23P 19/04

(52) U.S. Cl. 224/600; 29/428

(57) ABSTRACT

Provided is a storage compartment allowing quick deployment of emergency equipment stored therein, where the compartment comprises a first door that is opened and the equipment deployed in response to pulling a pull cord connected to the compartment or an electronic signal. Also provided is a bag comprising emergency equipment within a compartment deployable by a user while wearing the bag, where the bag is configured to deploy the piece of equipment in response to pulling a pull cord connected to the bag or an electronic signal. Additionally, a bag configured to house a gas mask and gas mask equipment is provided, where the bag is configured to deploy the gas mask from the bag in response to an action by a user.

### CROSS-REFERENCE TO RELATED APPLICATION

This application claims the benefit of U.S. application Ser. No. 12/359,308, filed Jan. 24, 2009; which is incorporated herein by reference in its entirety.

### TECHNICAL FIELD

Provided are methods and apparatuses for storing equipment. More particularly, apparatus, including backpacks, are provided that allow quick and convenient deployment of equipment such as emergency equipment, for example gas masks.

### BACKGROUND OF THE INVENTION

There is a need in many situations for the quick deployment of gear or equipment from a storage location, including a backpack, storage pack attached to a belt (e.g., “fanny pack”), pouch on a vest or jacket, cabinet in a home or office (e.g., storage cabinet for defibrillator), where, in some cases, the person wearing or carrying the storage apparatus has limited mobility or limited ability to manipulate the carrying apparatus, or needs quick access to the gear or equipment. Examples of such situations include an immediate need for medical equipment (e.g., defibrillator), a rock climber in need of an emergency tool, a fireman in need of a piece of special equipment (e.g., fire shelter), or a soldier in need of a gas mask. In each case, the ability to quickly deploy the equipment using minimum effort is critical.

With terrorism on the rise, the soldiers in the U.S. military are likely to encounter chemical, biological or radiological (CBR) threats. To help protect the soldiers, a gas mask must be used. Currently, soldiers are required to carry an abundance of gear, and they are running out of room for additional tactical gear, such as a gas mask. Between issued sub loads for pistols, flash bangs, and other ordnance, soldiers cannot add any more items on thigh rigs or web belts.

In addition for having space for the gas mask and associated equipment to filter the air for the mask, a system for storage and deployment of a gas mask often needs to have a fast deployment mechanism. It would be desirable to have a fast deployment system that can deploy the gas mask and make the mask accessible to the user in response to a single action by the user. It would also be advantageous to store the gas mask system in one place. Often other gas mask equipment, such as a blower, needs to be carried and stored as well. The wearer of the mask may also desire to store other items with the gas mask system and therefore does not want the items to become entangled with the gas mask system. The compositions and methods disclosed herein address the above needs.

### BRIEF SUMMARY OF EMBODIMENTS OF THE INVENTION

Provided is a storage compartment allowing quick deployment of emergency equipment stored therein. The compartment comprises a first door that is opened and the equipment deployed in response to pulling a pull cord connected to the compartment.

Also provided is a bag comprising emergency equipment within a compartment deployable by a user while wearing the bag, wherein the bag is configured to deploy the piece of equipment in response to pulling a pull cord connected to the bag.

Additionally, a bag is provided that is configured to house a gas mask and a gas mask equipment connected to the gas mask via a conduit. The bag is configured to contain the gas mask inside the bag and to deploy the gas mask from the bag in response to an action by a user of the gas mask when the gas mask is housed inside the bag. The bag is also configured to house the gas mask equipment while the gas mask is worn by the user.

In a variant of the bag, the action by the user comprises pulling a pull cord connected to the bag.

In another variant, the bag comprises a backpack with a strap for securing the backpack to the user. The backpack has a first compartment that has a window and is configured to quickly release the gas mask through the window in response to an action by the user.

In a further variant, the backpack further comprises a pull cord configured to cause the first compartment to deploy the gas mask when the pull cord is pulled by the user.

In still another variant of the backpack, a tab is disposed on the strap of the backpack. The tab has first and second sides and top and bottom faces. The bottom face of the tab has Velcro disposed thereon. The tab is configured to receive the pull cord underneath the tab between the bottom face and the strap. The pull cord further comprises a Velcro section of a Velcro type configured to secure to the Velcro disposed on the bottom face of the tab. The pull cord Velcro section is configured to be received between the tab's bottom face and the strap, so that the pull cord is precluded from being inadvertently pulled by the user or other forces.

In yet a further variant, the backpack further comprises a second compartment configured to house a gas mask equipment while the equipment operates. According to another embodiment, the second compartment further comprises an exit opening for the conduit.

In another variant, the backpack comprises a locking mechanism for preventing the first compartment from inadvertently deploying a gas mask stored in the first compartment. The pull cord is configured to operate the locking mechanism and is configured to release the locking mechanism and cause the backpack to deploy a gas mask stored in the first compartment. In one embodiment, the locking mechanism comprises a ring connected to the first compartment and a loop connected to the backpack. The loop is configured to extend through the ring and is configured to receive the pull cord. The backpack is convertible between a deployed state and an undeployed state. When the loop is disposed through the ring and the pull cord is disposed through the loop, the backpack is in the undeployed state. When a gas mask is stored in the first compartment and the backpack is worn by the user in an undeployed state, the backpack is configured such that if the user pulls the pull cord, the pull cord will move out of the loop and permit the weight of the gas mask to push the first compartment to open and allow the gas mask to drop through the window.

In a further variant of the backpack, the pull cord is configured to unlock the locking mechanism when the pull cord is pulled. This causes a gas mask stored in the first compartment to deploy out of the backpack.

In still another variant, the first compartment comprises a gas mask deployment window and at least one flap for opening and closing the gas mask deployment window. When the pull cord is pulled while the backpack is worn by the user, the backpack is configured to permit the flap to open when a mask is stored in the first compartment.

In another variant of the backpack, a first opening permits passage of the pull cord into the backpack. A second opening permits passage of the pull cord out of the backpack. The backpack further comprises a locking mechanism for engaging the pull cord and preventing the flap from opening when the pull cord is engaged with the locking mechanism. When the pull cord is engaged with the locking mechanism and the pull cord is pulled by the user, the locking mechanism is configured to disengage with the pull cord and permit the flap to open and deploy a gas mask stored in the first compartment.

In a further variant, the backpack comprises a third opening leading into the first compartment, for permitting passage of the pull cord into the first compartment. The second opening leads from the first compartment to outside the backpack. The backpack further comprises a channel attached to an inside wall of the first compartment, configured to receive the pull cord through the channel. The pull cord comprises a main line and a second line connected to the main line. The second line comprises a first end connected to the main line and a second end having a stop. The second line is configured to be received through the channel. The stop and the channel are configured to impede the pull cord from being pulled beyond a predetermined distance.

In yet a further embodiment, the backpack further comprises a main compartment for the storage of articles. A first opening permits passage of the pull cord into the backpack, the first opening leading into the main compartment. A second opening permits passage of the pull cord out of the main compartment. A locking mechanism engages the pull cord and prevents the flap from opening when the pull cord is engaged with the locking mechanism. When the pull cord is engaged with the locking mechanism and the pull cord is pulled by the user, the locking mechanism is configured to disengage with the pull cord and permit the flap to open and deploy a gas mask stored in the first compartment.

In another variant of the backpack, a channel is attached to an interior wall of the main compartment. The channel is configured to receive the pull cord through the channel for preventing entanglement of the pull cord with the articles in the main compartment.

In a further variant of the backpack, the second opening for permitting passage of the pull cord out of the main compartment leads into the first compartment. The backpack further comprises a third opening for permitting passage of the pull cord out of the first compartment. The locking mechanism is disposed on the outside of the backpack and on the flap.

In a still another variant of the backpack, the second opening permits passage of the pull cord out of the main compartment and leads into the first compartment. A third opening permits passage of the pull cord out of the first compartment. The locking mechanism is disposed on the outside of the backpack and on the flap.

In yet a further variant, a method for rigging a backpack to quickly deploy a gas mask stored in the backpack is provided. The backpack houses a gas mask equipment connected to the gas mask via a conduit. The method comprises: providing a backpack with a first section having an open side for storing the gas mask and a second section for storing the gas mask equipment, the first section disposed below the second section when the back pack is worn by a user; placing a gas mask equipment in the second section; placing a gas mask connected to the gas mask equipment via a conduit into the first section; folding flaps of the first section over the conduit and to cover the open side so that the conduit protrudes from between the folds; and inserting a pull cord into a locking mechanism configured to prevent the folded flaps of the first section from unfolding. When the pull cord is pulled by a user while wearing the rigged backpack, the locking mechanism is configured to permit the folded flaps to open and deploy the gas mask.

In another variant, a backpack is configured to house a gas mask and a gas mask equipment connected to the gas mask via a conduit. The backpack comprises: a first backpack section configured to house the gas mask inside the backpack; and a removable second backpack section configured to house the gas mask equipment while the gas mask is worn by the user and the gas mask equipment is operating. The second backpack section comprises: a fastening mechanism for connecting and disconnecting the second backpack section from the first backpack section; an exit opening for permitting connection between the gas mask equipment housed inside the second backpack section and the gas mask; and at least one strap for securing the second backpack section to the user when the second backpack section is disconnected from the first backpack section. The second backpack section is configured to permit a user to operate the gas mask on the user's face while the second backpack section and gas mask equipment is secured to the user via the strap. The backpack is configured to deploy the gas mask from the first backpack section in response to a single action by a user of the gas mask, when the gas mask is housed inside the backpack.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a front view of a preferred backpack for quick deployment and storage of a gas mask in accordance with the principles of the invention, with a user wearing the backpack.

FIG. 2 is a front view of a user wearing the backpack and pulling a pull cord in accordance with various embodiments.

FIG. 3 is a back view of a user wearing the backpack with the gas mask undeployed in the first compartment in accordance with various embodiments.

FIG. 4A is a back view of a user wearing the backpack with the gas mask deployed from the first compartment in accordance with various embodiments; FIG. 4B is a back view of a user wearing the backpack with the gas mask deployed from the first compartment and the gas mask being operated by the user while the gas mask equipment is toted by the backpack in accordance with various embodiments.

FIG. 5 is a perspective view of a main compartment of the backpack in accordance with various embodiments.

FIG. 6 is a cutaway view of the first compartment, opened, configured to house and deploy the gas mask in accordance with various embodiments.

FIG. 7 is a perspective view the first compartment illustrating the processes of converting the backpack from a deployed state to an undeployed state in accordance with various embodiments.

FIG. 8 is a perspective view of a bottom of the backpack when the backpack is in an undeployed state in accordance with various embodiments (a conduit is omitted for purposes of clearer illustration).

FIG. 9 is a close up view of a locking mechanism for maintaining the backpack in the undeployed state in accordance with various embodiments.

FIG. 10 is a perspective view illustrating a smaller repeatable connectable and disconnectable component of the backpack, configured to house the gas mask equipment and to permit the user to only tote the gas mask equipment in the smaller component in accordance with various embodiments.

FIG. 11 is a perspective view illustrating the gas mask equipment housed inside the smaller component of the backpack and detached from the backpack in accordance with various embodiments.

FIG. 12 is a top perspective view of the backpack, while a user wears the backpack, illustrating a first opening for permitting the pull cord to enter into the backpack in accordance with various embodiments.

FIG. 13 is a flow chart illustrating a method for rigging a backpack to quickly deploy a gas mask stored in the backpack in accordance with various embodiments.

FIG. 14 is a perspective view of a side release buckle configured to open a compartment upon pulling a pull cord.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. If a definition set forth in this section is contrary to or otherwise inconsistent with a definition set forth in applications, published applications and other publications that are herein incorporated by reference, the definition set forth in this document prevails over the definition that is incorporated herein by reference.

The presence of broadening words and phrases such as “one or more,” “at least,” “but not limited to” or other like phrases in some instances shall not be read to mean that the narrower case is intended or required in instances where such broadening phrases may be absent.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. In addition, when a single callout line in the drawings leads to two or more separate reference numbers (first, second, etc. reference numbers), and each reference number refers to a different piece of text in the detailed description, and it would be inconsistent to designate the drawing item being called out to both pieces of text, the drawing shall be interpreted as illustrating two different variants. In one variant, the drawing item is referred to by the first reference number and in another variant the drawing item is referred to by the second reference number, and in a third variant the drawing item is referred to by the third reference number if more than two reference numbers, etc.

Provided herewith are apparatuses and methods for the rapid and facile deployment of equipment from a compartment (e.g., a cabinet, backpack, or pouch on an article of clothing).

In some embodiments, a storage compartment is provided that allows quick deployment of emergency equipment stored therein. The compartment comprises a first door that is opened and the equipment deployed in response to pulling a pull cord connected to the compartment or an electronic signal.

As used herein, “emergency equipment” includes any piece of equipment that is not normally used but is generally only stored to be used in an emergency that is not specifically predictable. Nonlimiting examples of emergency equipment is medical equipment (e.g., a defibrillator, a bandage, an epinephrine injector), a gas mask, a tool (e.g. a knife, a wire cutter, a pliers, a scissors), a portable shelter (e.g, to protect firefighters from wildfire), a flare, a flashlight, a GPS system, or a weapon (e.g., a firearm or a knife).

The storage compartment is not narrowly limited to any particular configuration, but includes free standing compartments, compartments attached to a wall, or compartments suitable for wearing. The storage compartment can be any size suitable for storing emergency equipment.

In some embodiments, the storage compartment is not in a wearable configuration. Such embodiments include a compartment in a hospital, office, storage shed, airplane, ground vehicle (e.g., in an automobile, truck or ambulance, for example attached to the back of a vehicle seat or within the dashboard of a vehicle or inside the trunk), tent, or bunker, or outdoors. The compartment can be free standing, or in a section of a free standing structure. Alternatively, the compartment can be mounted on a wall or a table, or unmounted, e.g., stowed or on a shelf, where it can be easily retrieved in an emergency.

In other embodiments, the storage compartment is in a wearable configuration, including but not limited to a backpack, a belt pack (i.e., a “fanny pack”), or a pocket of any suitable size that is temporarily or permanently affixed to clothing, e.g., on a vest, jacket, coat, pants, flight suit, or wetsuit. Included here are molle packs, a compartment attachable to a uniform (e.g., of military, police or firefighter), a health professional's lab coat or scrubs, or any other emergency responder.

In various embodiments, the storage compartment is opened and the equipment deployed in response to an electronic signal, e.g., activating a radio frequency remote control, or using an electronic switch, as are known in the art (for example as described in U.S. Pat. No. 3,597,633) configured to unlatch the compartment upon activation of the switch by engaging an activation means, e.g., by pushing a button. The activation of the switch can be by a wire connected between the activating means and the latch that is opened electronically. Alternatively, the activation can be by wireless signal, as is known in the art.

In other embodiments, pulling a pull cord opens a locking mechanism that otherwise keeps the first door of the storage compartment closed. These embodiments are not narrowly limited to any particular locking mechanism. Examples of suitable mechanisms include Velcro, a snap, a clip, a side release buckle, a lanyard, a spring, a magnet, a piece of foam compressed over the opening of the compartment, or a loop inserted into a ring with the pull cord deployed through the loop.

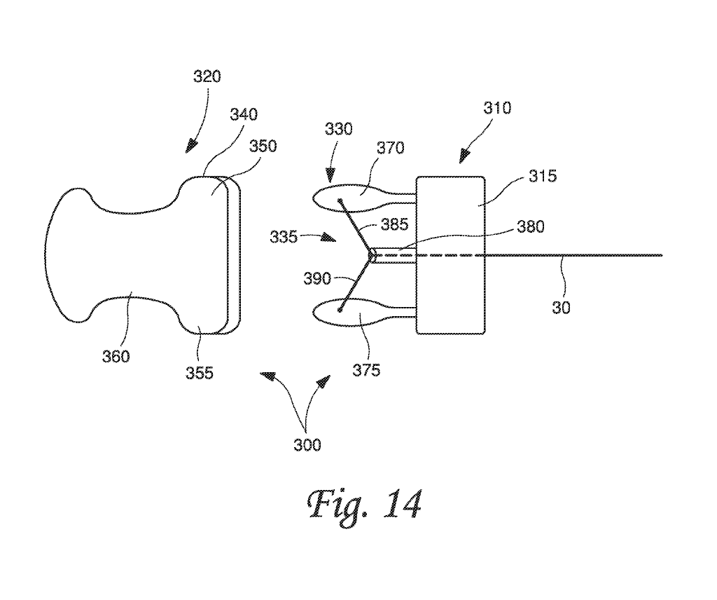

An example of a side release buckle mechanism suitable as a locking mechanism for these embodiments is illustrated in FIG. 14. The side release buckle 300 comprises a male member 310 and a female member 320. The male member comprises a longitudinally extending axis, a tongue portion 330 and a base portion 315. The female member comprises a longitudinally extending axis, a receptacle 340, defined partially by first and second substantially opposed side walls 350, 355, for receiving the tongue portion 330 of the male member 310, and a latching portion 360 for releasably retaining the tongue portion 330 of the male member within the receptacle 340. An opening 335 is defined within and extending through a substantially axially central portion of the tongue portion 330 of the male member 310 so as to define upon the tongue portion 330 of the male member a pair of laterally spaced, flexible latching arms 370, 375 for releasably engaging the latching portion 360 of the female member 320. The pull cord 30 is attached to the flexible latching arms 370, 375 of the male member 310 from between the two flexible latching arms 370, 375 such that when the pull cord is pulled, the flexible latching arms 370, 375 are released from the latching portion 360 of the female member, opening the first door and deploying the equipment.

The pull cord can attach to the flexible latching arms 370, 375 by any means known in the art. In the example illustrated in FIG. 14, the pull cord 30 passes through the base portion 315 and a central conduit 380, where it divides into two sections 385, 390, where one section 385 attaches to one flexible latching arm 370 and the other section 390 attaches to the other flexible latching arm 375. Upon pulling the pull cord 30, the two sections 385, 390 are drawn toward the central conduit 380, causing the flexible latching arms 370, 375 to be drawn toward the opening 335 in the tongue portion 330, thus releasing the flexible latching arms 370, 375 from the latching portion 360 of the female member 320.

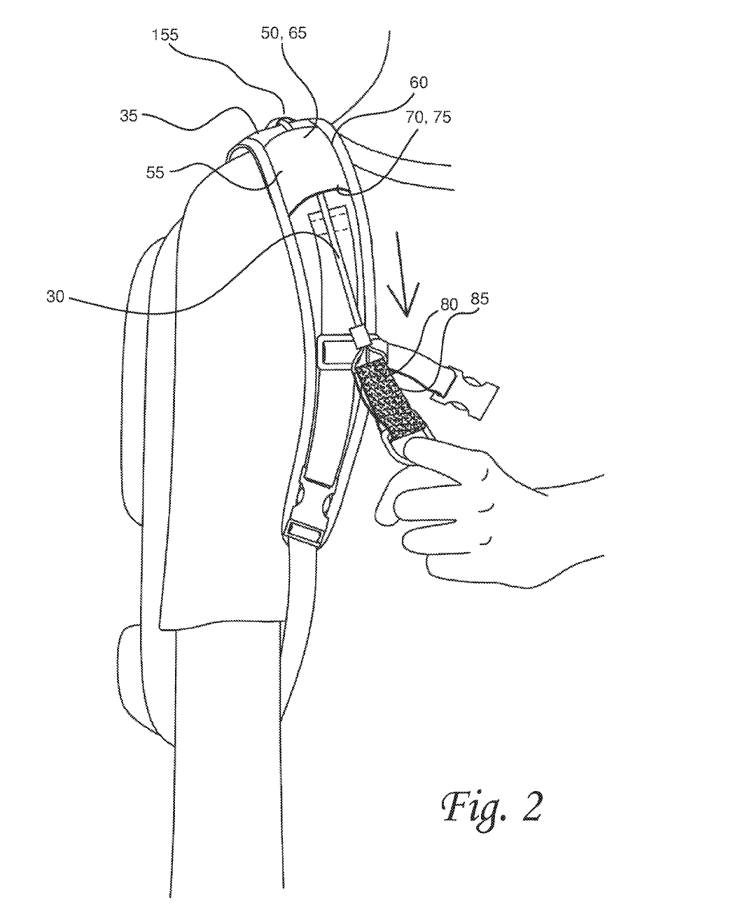

In other embodiments, e.g. as shown in FIGS. 2, 5, 6 and 9, the locking mechanism 100 comprises a ring 105 connected to a first loop 110 that is secured to a flap 115 of the first compartment 40. A second loop 120 is connected to an outer surface 101 of the backpack 10 on the bottom portion 42. The second loop 120 is configured to extend through the ring 105. The second loop 120 is also configured to receive the pull cord 30. Optionally, the backpack 10 may have a third loop 125 configured to receive a second end 130 of the pull cord 30. The third loop 125 is spaced apart from the second loop 120 and is preferably generally aligned with the second loop 120 so that the pull cord 30 may be received in both second and third loops without much bending.

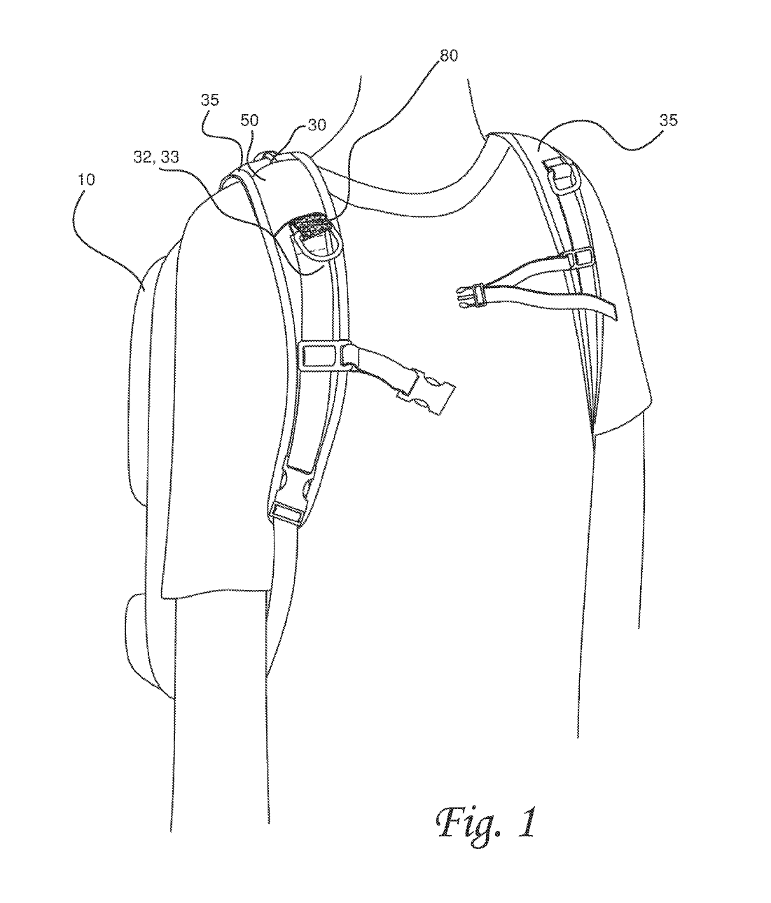

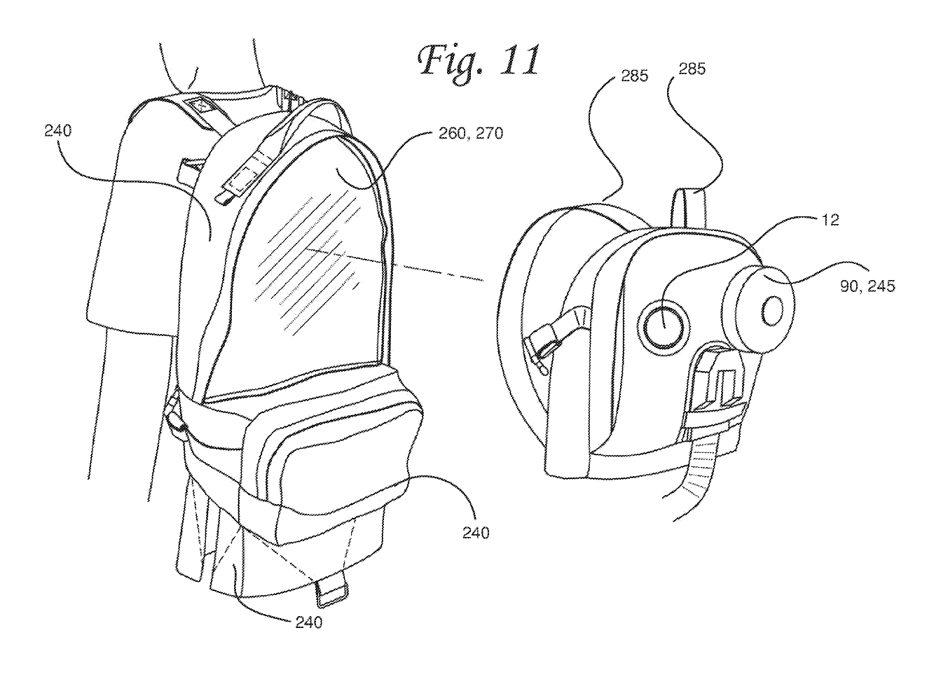

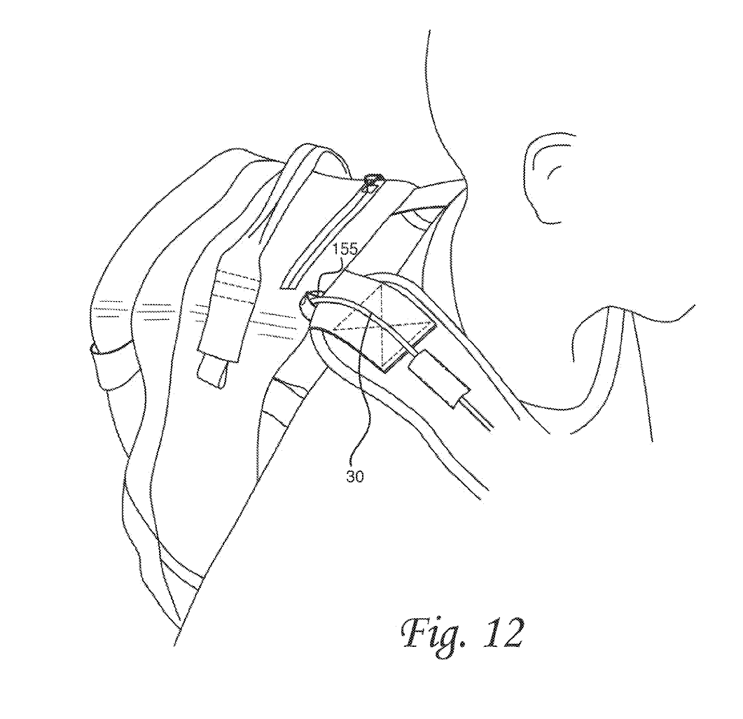

In some embodiments, the storage compartment is a backpack and the first door is a flap on the backpack, as exemplified in FIGS. 1-13. In various aspects of these embodiments, also as exemplified in FIGS. 1-13, the emergency equipment is a gas mask, as further described below.

The pull cord of these embodiments can be of any design or capability known in the art. For example, in some embodiments the pull cord is also attached to a second door that opens a second compartment, e.g., to deploy a second piece of equipment. The pull cord can be connected to any number of compartments, which can all be opened by pulling on the pull cord. Alternatively, such a second compartment can be opened with a second pull cord. The pull cord can also be designed such that the first door opens only when the pull cord is pulled in a specified direction. Such mechanisms are known in the art. See, e.g., U.S. Pat. No. 4,352,386.

Additionally, in some embodiments where a pull cord is connected to more than one compartment, the pull cord can be configured where the door of the first compartment opens when the pull cord is pulled in a first specified direction, and the door of a second compartment is opened when the pull cord is pulled in a second specified direction. Alternatively, the pull cord may be pulled a first distance to open the first compartment or a second distance to open the second compartment.

In some embodiments, pulling the pull cord opens the first door such that the first door remains open until the first door is manually closed and the locking mechanism is engaged. In other embodiments, releasing the pull cord causes the first door to close, for example if the locking mechanism comprises a spring between the door and another part of the compartment, where pulling the pull cord causes the door to open by expanding the spring, and releasing the pull cord causes the spring to contract, closing the door.

Also provided is a bag comprising emergency equipment within a compartment deployable by a user while wearing the bag. In these embodiments, the bag is configured to deploy the emergency equipment in response to pulling a pull cord connected to the bag, or an electronic signal.

In place of the cord, a wire, cable, belt or any other device known in the art for pulling open a closed compartment or opening a closed sealing mechanism can be used.

As with the storage compartment discussed above, the bags of these embodiments can hold any emergency equipment, for example medical equipment, a gas mask, a tool, a portable shelter, a flare, a flashlight, a GPS system, or a weapon.

In some of these embodiments, the bag is opened and the equipment deployed in response to an electronic signal, as discussed above in relation to the storage compartment. In alternative embodiments, the emergency equipment is deployed in response to pulling a pull cord connected to the bag.

In some embodiments where the equipment is deployed by pulling a pull cord, such a deployment completely releases the equipment from the bag so that the equipment can be used away from the bag. Such embodiments can be useful, e.g., where the emergency equipment is a knife, a firearm, or a shelter. In alternative embodiments, the emergency equipment is coupled to the bag within a compartment deployable by pulling the pull cord, and the bag is configured to couple to the piece of equipment while the piece of equipment is used by the user. These embodiments are useful, e.g., were the equipment is a gas mask where gas mask equipment that must be connected to the gas mask while in use is in the bag. These alternative embodiments are also useful where there is a danger of losing the emergency equipment upon deployment, e.g., when rock climbing, or when the equipment is a flashlight that could get lost in the dark. The equipment may be coupled to the bag, for example, by using a cord, lanyard, cable or strap. In another embodiment, the cord, lanyard, cable or strap may be retractable, so that after use, the equipment may be retracted back into the compartment from with it was deployed, using mechanisms known in the art.

The bag of these embodiments can be any wearable item, for example a backpack, a belt pack, or a pocket of any suitable size temporarily or permanently affixed to clothing, e.g., on a vest, jacket, coat, pants, flight suit, or wetsuit.

In various embodiments, the bag is a backpack and the emergency equipment is a gas mask, as further discussed below.

In various embodiments, pulling the pull cord opens a locking mechanism that otherwise keeps the compartment closed preventing deployment of the equipment. These embodiments are not narrowly limited to any particular locking mechanism. Examples of suitable mechanisms include Velcro, a snap, a clip, a side release buckle, a lanyard, a spring, a magnet, a piece of foam compressed over the opening of the compartment, or a loop inserted into a ring with the pull cord deployed through the loop.

In some embodiments, the locking mechanism comprises a side release buckle, e.g., as discussed above in relation to the storage compartment embodiments. Alternatively, the locking mechanism comprises a loop inserted into a ring with the pull cord deployed through the loop, also as detailed above in relation to the storage compartment embodiments.

Additionally provided is a bag or a backpack 10 for quickly deploying a gas mask from the bag 10 in response to a single action by a user, e.g., an electronic signal, as discussed above in relation to the storage compartment embodiments, or a pull cord.

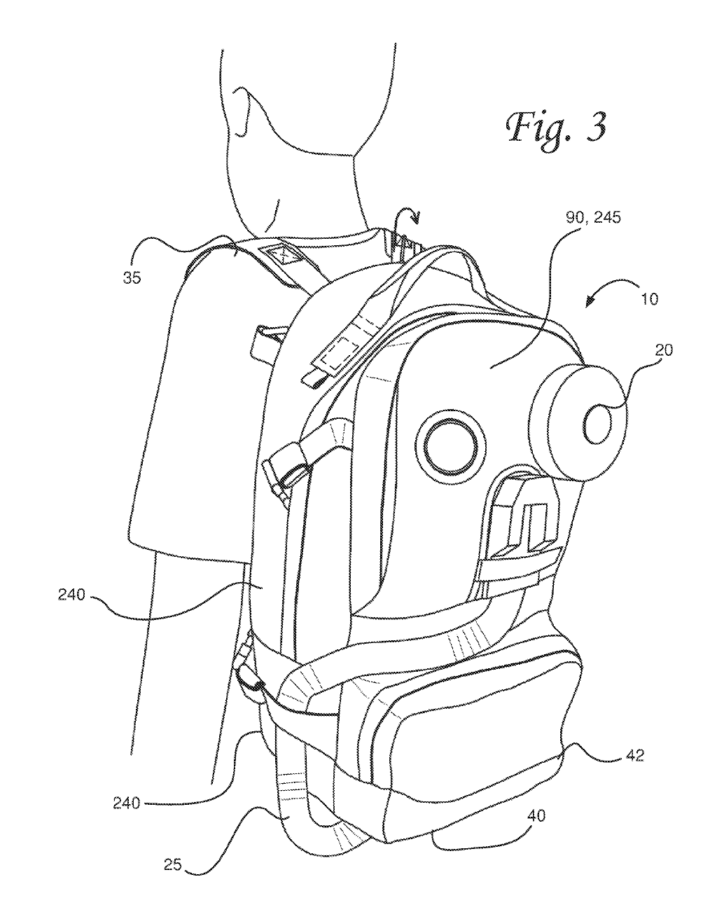

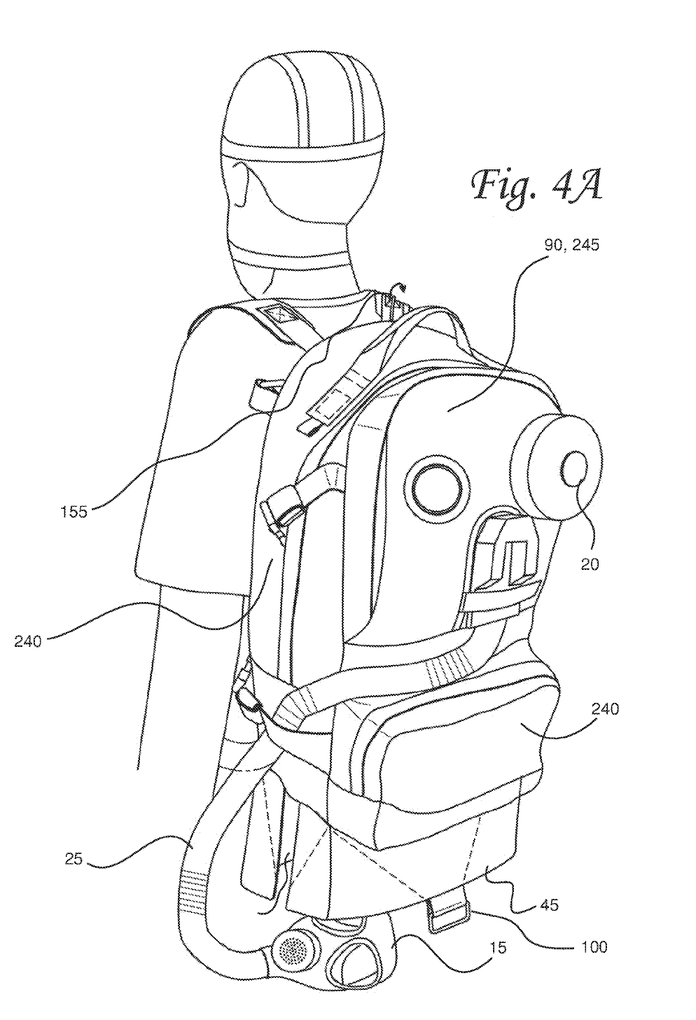

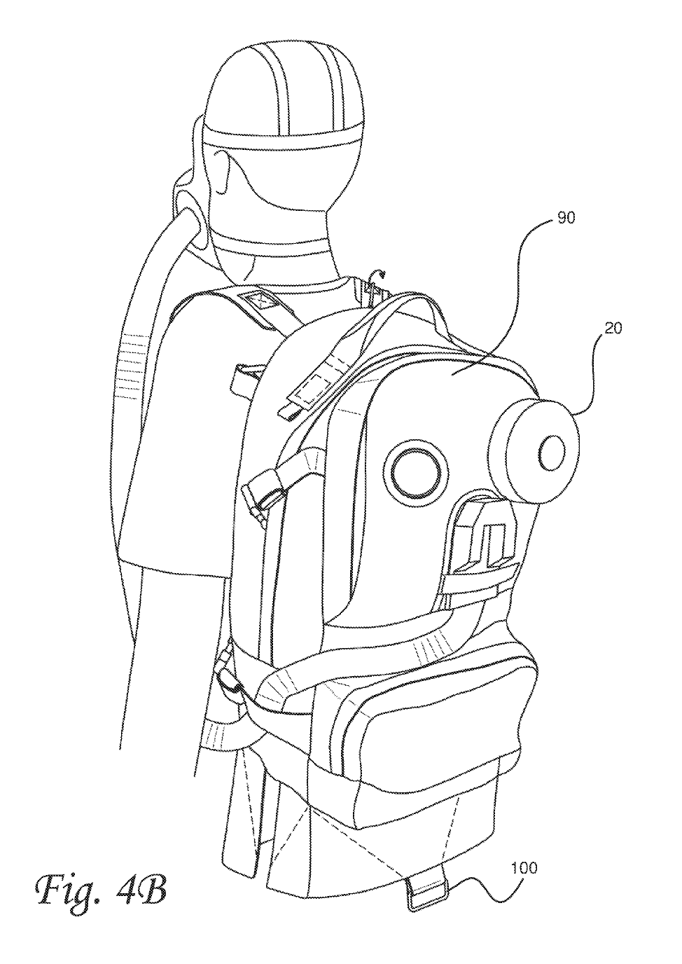

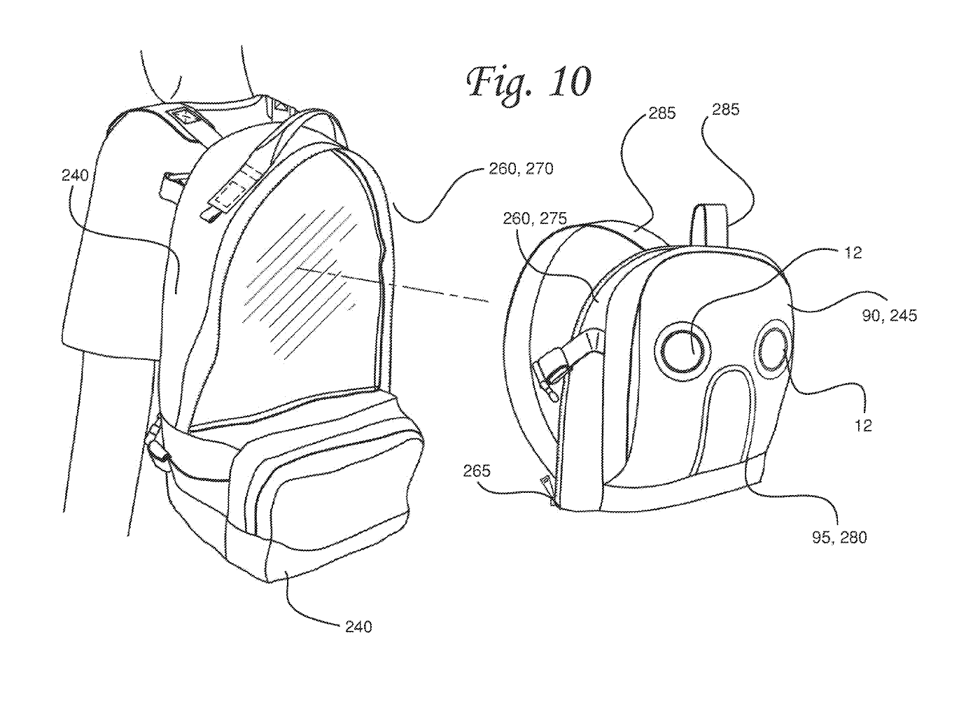

In one variant, referring to FIGS. 3-4B, a bag 10 is configured to house a gas mask 15 and gas mask equipment 20 connected to the gas mask 15 via a conduit 25. The bag 10 is configured to contain the gas mask 15 inside the bag 10. The bag 10 is configured to deploy the gas mask 15 from the bag in response to an action by a user of the gas mask 15, when the gas mask is housed inside the bag 10. The bag is also configured to house the gas mask equipment 20 while the gas mask 15 is worn by the user. In one embodiment, referring to FIG. 10, the bag 10 has through holes 12 configured to permit portions of the gas mask equipment 20 to protrude from the bag 10 so that the equipment can function properly.

In another variant of the bag 10, referring to FIGS. 1 and 2, the action by the user may comprise pulling a pull cord 30 connected to the bag 10. The pull cord 30 may have a handle or ring 32 at a first end 33 of the pull cord 30. The pull cord 30 is preferably made of stiff yet bendable material such as a rope wire and has a smooth sheath.

In a further variant, referring to FIGS. 1-4B, the bag 10 may function as a backpack 10. The backpack 10 may include a pair of straps 35 for securing the backpack 10 to the user. The backpack 10 has a first compartment 40 configured to store the gas mask 15 inside the backpack 10. The first compartment 40 has a window 45 and the first compartment 40 is configured to quickly release the gas mask 15 through the window 45 in response to an action by the user. In one example, as illustrated in FIG. 2, the action may be pulling a pull cord 30. FIGS. 4A and 4B also illustrate the process of the gas mask 15 released from the first compartment 40 (FIG. 4A) and then being worn by the user while the gas mask equipment is stored while being operated while in the backpack 20 (FIG. 4B).

In still another variant, the backpack 10 has a pull cord 30 configured to cause the first compartment 40 to deploy the gas mask 15 when the pull cord 30 is pulled by the user. The single action by user may comprise pulling the pull cord 30. Referring to FIGS. 3, 4A and 4B, when the pull cord 30 is pulled by a user, the pull cord moves in the direction of the arrow, coming out of the backpack 10. In an alternative embodiment, the single action may comprise activating an electronic signal by, e.g., pressing a button or activating a radio frequency remote control to release the gas mask, or pushing a button mechanically connected to the release mechanism for the gas mask.

In yet a further variant, referring to FIGS. 1 and 2, the backpack 10 has a tab 50 disposed on one of the straps 35. The tab 50 has first 55 and second 60 sides and top 65 and bottom 70 faces. The bottom face 70 has Velcro 75 disposed thereon. The tab 50 is configured to receive the pull cord 30 underneath the tab 50 between the bottom face 70 and the strap 35. The pull cord 30 may also include a Velcro section 80 having a Velcro type 85 disposed on the Velcro section 80 configured to secure to the Velcro 75 disposed on the bottom face of the tab. Referring to FIG. 1, the pull cord Velcro section 80 is configured to be received between the tab's 50 bottom face 70 and the strap 35 so that the pull cord 30 is precluded from being in advertently pulled by the user or other forces, for example, if the pull cord 30 got snagged on an object while the user was moving about.

In another variant, referring to FIGS. 3, 4A, 4B, and 10, the backpack 10 has a second compartment 90 configured to house a gas mask equipment 20 while the equipment 20 operates.

In a further variant of the backpack 10, the second compartment 90 may have an exit opening 95 for the conduit 25.

In still another variant, referring to FIGS. 4A, 4B, 8 and 9, the backpack 10 may have a locking mechanism 100 for preventing the first compartment 40 from inadvertently deploying a gas mask 15 stored in the first compartment 40.

In yet a further variant of the backpack 10, the pull cord 30 is configured to operate the locking mechanism 100. The pull cord 30 is configured to release the locking mechanism 100 and cause the backpack 10 to deploy a gas mask 15 stored in the first compartment 40. The first compartment 40 is preferably disposed at a bottom portion 42 of the backpack such that when a user wears the backpack while standing on a surface, the window 45 of the first compartment 40 opens downward toward the ground.

In another variant of the backpack, as illustrated in FIGS. 7, 8 and 9, the locking mechanism comprises a ring connected to a first loop that is secured to a flap of the first compartment, as detailed above in relation to the storage compartment embodiments.

In still another variant of the backpack, as illustrated in FIG. 14, the locking mechanism can be a side release buckle, as detailed above in relation to the storage compartment embodiments.

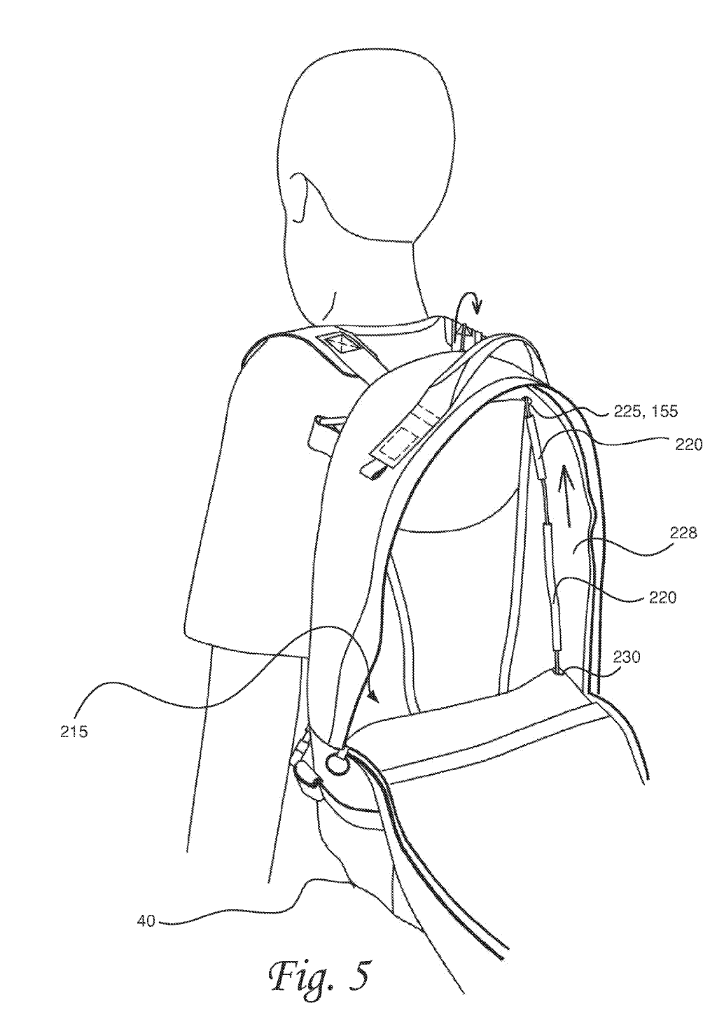

Alternatively to the disposition of the deployable compartment on the bottom of the bag, an embodiment provides for a side compartment having a release mechanism configured similarly to that shown in FIGS. 2 and 5, but with the pull cord threaded through additional channels along the interior bottom portion of main compartment 215 and then through an exterior flap on the opposite side of the bag to the top of the cover flap of a side compartment which is maintained in place by a single fastener, such as, for example, a snap, Velcro, side release buckle, or another locking mechanism as described above. Upon a pulling force being applied to the pull cord, the fastener is released and the compartment opens to allow a component, such as, for example, a gas mask to exit the bag and hang freely for quick access. In place of a gas mask, the compartment could contain medical equipment, tools, emergency equipment, food, or some other item or items, which can be secured to the bag by a cord or lanyard to prevent loss of the item and to allow quick access to the item by the user without the need to remove the bag.

The backpack 10 is convertible between a deployed state illustrated in FIGS. 2 and 4 and an undeployed state illustrated in FIGS. 1 and 3. When the second loop 120 is disposed through the ring 105 and the pull cord 30 is disposed through the loop 120, the backpack 10 is in the undeployed state. In the undeployed state, the pull cord 30 prevents the ring 105 from moving away from the second loop 120, and thus the flap 115 is prevented from opening the window 45 and allowing a gas mask 15 stored in the second pouch from escaping.

When a gas mask 15 is stored in the first compartment 40, the backpack 10 is worn by the user and the backpack 10 is in the undeployed state, the backpack 10 is configured such that if the user pulls the pull cord 30, the pull cord 30 will move out of the second loop 120 and permit the weight of the gas mask 15 to push the first compartment 40 to open and allow the gas mask 15 to drop through the window 45.

In a further variant of the backpack 10, the pull cord 30 is configured to unlock the locking mechanism when the pull cord 30 is pulled and cause a gas mask stored in the first compartment to deploy out of the backpack.

In still another variant of the backpack, the first compartment comprises 40 a gas mask deployment window 45 and at least one flap 115 for opening and closing the gas mask deployment window 45.

Alternatively, the first compartment 40 may include on its internal portion a hook (not shown) coupled to the gas mask. Upon pulling of the pull cord 30 the door of the first compartment 40 opens which in turn pulls the gas mask clear of the first compartment 40 and causes the gas mask to release from the hook (not shown) and become free of the first compartment 40.

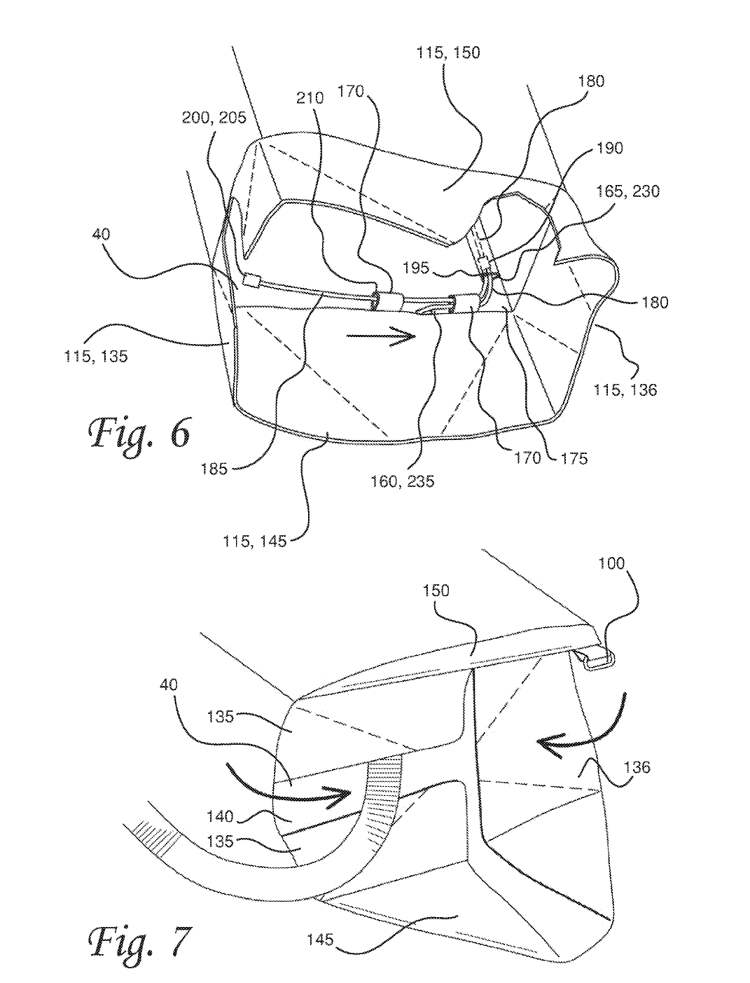

Optionally, referring to FIGS. 6, 7 and 8, the first compartment 40 may have four flaps 115 configured to be folded in a manner so that a conduit 25 from a gas mask 15 stored in the first compartment 40 can be disposed between the stored gas mask 15 and the gas mask equipment 20 housed in a different compartment of the backpack 10, while the flaps 115 are folded to close the window 45 to store the gas mask 15.

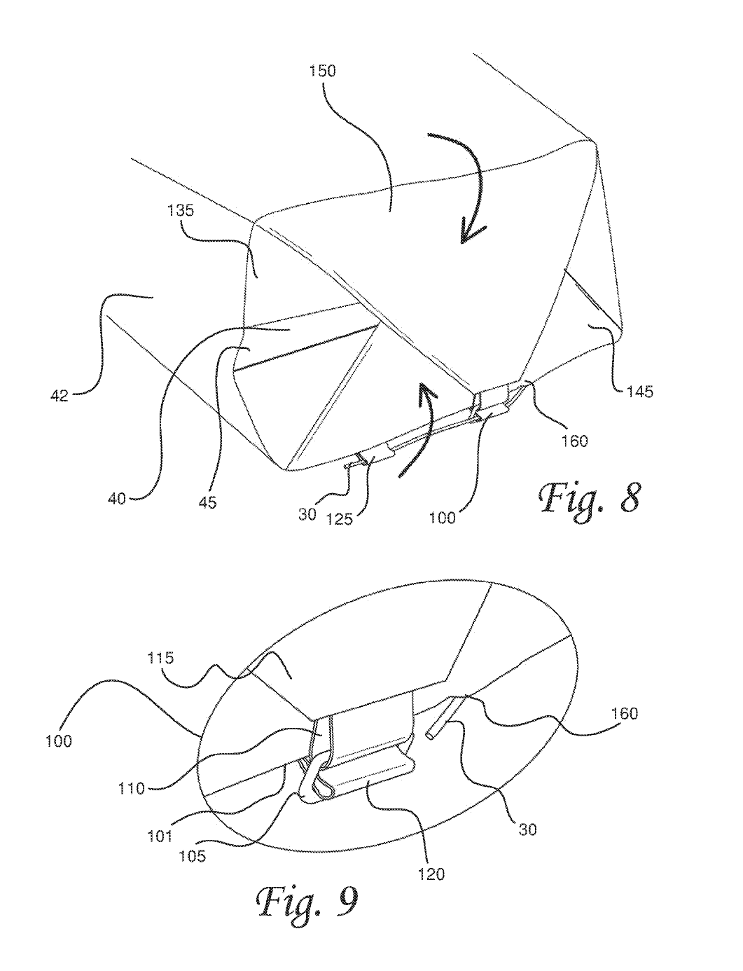

In one optional example, starting with the window 45 completely open in FIG. 6, two left side flaps 135 are configured to first fold down as shown in FIG. 7, resulting a narrow opening 140 to permit placement of the conduit 25. A right side flap 136 may be folded down either before or after left side flaps 135. Next, referring to FIG. 8, a bottom flap 145 that is folded to form a triangular shape is folded over the side flaps 135 136. Finally, a top flap 150 that can be folded into a generally triangular shape and having the first loop 110 and ring 105 connect to it 150, may be folded over the remaining flaps 135, 140. The locking mechanism 100 may engage the pull cord 30 to lock the folded flaps 115. The locking mechanism 100 engaging the pull cord 30 may comprise receiving the second loop 120 into the ring 105 and then receiving the second end 130 of pull cord 30 through the second loop 120. Thereafter, when the pull cord 30 is pulled while the backpack 10 is worn by the user, the pull cord 30 will move out of the second loop 120 and permit the flaps 115 to open when a mask is stored 15 in the first compartment 40. The weight of the mask my cause the flaps 115 to open and permit the mask 15 to drop out of the backpack 10.

In yet a further variant, referring to FIGS. 4A, 6, and 12, the backpack 10 may have a first opening 155 for permitting passage of the pull cord 30 into the backpack. The backpack 10 may also have a second opening 160 for permitting passage of the pull cord 30 out of the backpack. The backpack may also include a locking mechanism 100 for engaging the pull cord 30 and preventing the flap 115 from opening when the pull cord 30 is engaged with the locking mechanism 100. When the pull cord 30 is engaged with the locking mechanism 100 and the pull cord 30 is pulled by the user, the locking mechanism 100 is configured to disengage with the pull cord 30 (as illustrated in FIG. 9), and permit the flap 115 to open and deploy a gas mask 15 stored in the first compartment 40.

In another variant, referring to FIG. 6, the backpack 10 may have a third opening 165 leading into the first compartment 40, for permitting passage of the pull cord 30 into the first compartment 40. The second opening 160 may be positioned such that it leads from the first compartment 40 to outside the backpack 10. One or more channels 170 may be attached to an inside wall 175 of the first compartment 40. The channel 170 may be configured to receive the pull cord 30 through the channel 170. Optionally, the pull cord 30 may comprise a main line 180 and a second line 185 connected to the main line 180 via an anchor 190. The second line 185 may comprise a first end 195 connected to the main line 180 at the anchor 190. The second line 185 may also comprise a second end 200 having a stop 205. The second line 185 is configured to be received through the channel 170 and the stop 205 and the channel 170 are configured to impede the pull cord 30 from being pulled beyond a predetermined distance. The stop 205 can catch on an outer end 210 of the channel 170 and thus prevent the pull cord 30 from being pulled too far so that the cord comes completely out of the backpack 10, for example. A user can more quickly rig the backpack back into the undeployed state if the pull cord 30 has not been pulled too far. The predetermined distance corresponds to the distance between the stop and the channel when backpack is in the undeployed state. Referring to FIG. 6, when the pull cord 30 is pulled by a user, the pull cord moves in the direction of the arrow.

In a further variant, referring to FIG. 5, the backpack 10 may preferably include a main compartment 215 for the storage of articles. The backpack may have a first opening 225 for permitting passage of the pull cord 30 into the backpack. The first opening 225 may lead into the main compartment 215. The backpack 10 may also include a second opening 230 for permitting passage of the pull cord 30 out of the main compartment 215. The backpack 10 may include a locking mechanism 100 for engaging the pull cord 30 and preventing the flap 115 from opening when the pull cord 30 is engaged with the locking mechanism 100. When the pull cord 30 is engaged with the locking mechanism 100 and the pull cord 30 is pulled by the user, referring to FIG. 9, the locking mechanism 100 is configured to disengage with the pull cord 30 and permit the flap 115 to open and deploy a gas mask 15 stored in the first compartment 40. Referring to FIG. 5, when the pull cord 30 is pulled by a user, the pull cord moves in the direction of the arrow.

In still another variant, the backpack 10 may include one or more channels 220 attached to an interior side wall 228 of the main compartment 215. The channel 220 is configured to receive the pull cord 30 through the channel 220 for preventing entanglement of the pull cord 30 with articles in the main compartment 215.

In yet a further variant of the backpack 10, the second opening 230 for permitting passage of the pull cord out 30 of the main compartment 215, leads into the first compartment 40. The backpack 10 may also include a third opening 235 for permitting passage of the pull cord 30 out of the first compartment 40. The locking mechanism 100 may be disposed on the outside surface 101 of the backpack 10 and on the flap 15.

In another variant, referring to FIGS. 3, 4A, 10, and 11, a backpack 10 is configured to house a gas mask 15 and a gas mask equipment 20 connected to the gas mask 15 via a conduit 25. The backpack 10 may include a first backpack section 240 configured to house the gas mask 15 inside the backpack 10. A removable second backpack section 245 is configured to house the gas mask equipment 20 while the gas mask 15 is worn by the user and the gas mask equipment 20 is operating. The first 240 and second 245 backpack sections may include a fastening mechanism 260 for connecting and disconnecting the second backpack section 245 from the first backpack section 240. Preferably, the fastening mechanism 260 is a zipper 265 having one track 270 disposed on the first backpack section 240 and a corresponding track 275 disposed on the second backpack section 255. The second backpack section 245 may include an exit opening 280 for permitting connection between the gas mask equipment 20 housed inside the second backpack section 245 and the gas mask 15. The second backpack section 245 has at least one strap 285 for securing the second backpack section 245 to the user when the second backpack section 245 is disconnected from the first backpack section 240. The second backpack section 245 is configured to permit a user to operate the gas mask 15 on the user's face while the second backpack section 245 and gas mask equipment 20 is secured to the user via the strap 285. The backpack 10 is configured to deploy the gas mask 15 from the first backpack section 240 in response to a single action by a user of the gas mask, when the gas mask is housed inside the backpack 10. Preferably, the second backpack section 245 is smaller and thus easier to carry than the combined first 240 and second 245 sections.

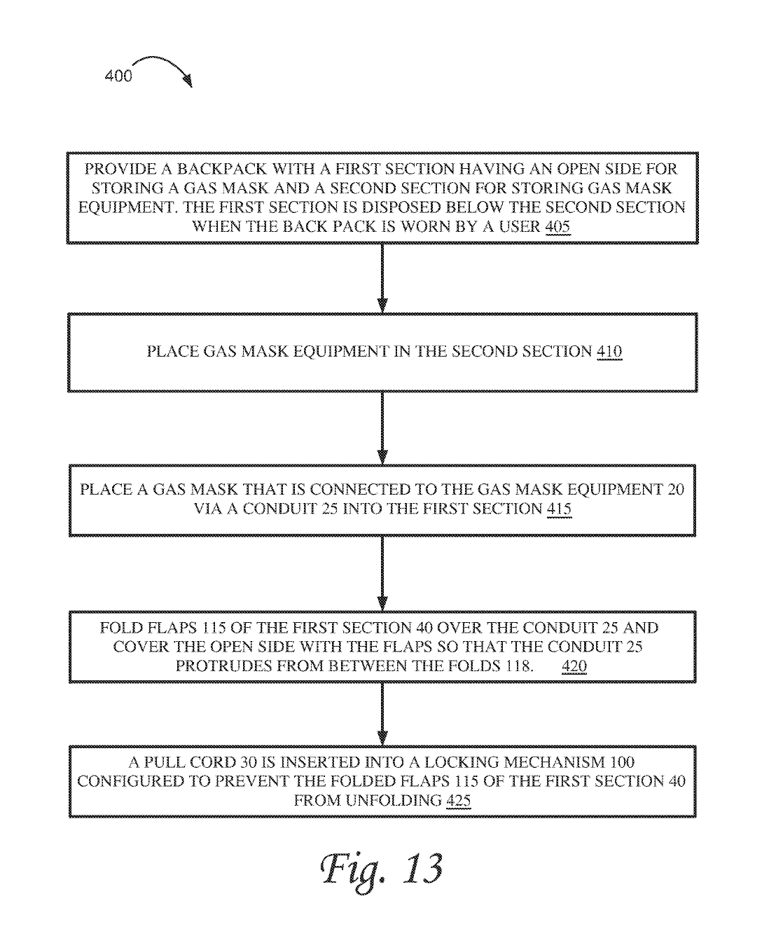

In a further variant, referring to FIG. 13, a method 400 is provided for rigging a backpack 100 to quickly deploy a gas mask 15 stored in the backpack 10 and the backpack capable of housing gas mask equipment 20 connected to the gas mask 15 via a conduit 25. In a step 405 a backpack is provided with a first section 40 having an open side for storing the gas mask and a second section for storing the gas mask equipment. The first section is disposed below the second section when the back pack is worn by a user as illustrated in FIG. 3. In a step 410, gas mask equipment is placed in the second section. In a step 415, a gas mask 15 connected to the gas mask equipment 20 via a conduit 25 is placed into the first section. In a step 420, flaps 115 of the first section 40 are folded over the conduit 25 and to cover the open side so that the conduit 25 protrudes from between the folds 118. In a step 425 a pull cord 30 is inserted into a locking mechanism 100 configured to prevent the folded flaps 115 of the first section 40 from unfolding. When the pull cord is pulled by a user while wearing the rigged backpack, the locking mechanism 100 is configured to permit the folded flaps 115 to open and deploy the gas mask, as illustrated in FIG. 4A.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

1. A wearable storage compartment allowing quick deployment of equipment stored therein, comprising:
a compartment having at least one strap, sleeve, or coupling device, and a door;
a securing device coupled to the compartment;
a deployment mechanism coupled to the securing device, wherein upon activation of the deployment mechanism the securing device is disengaged, the door is opened and the equipment is deployed to a location retrievable by a user.

2. The storage compartment of claim 1, wherein the deployment mechanism is a pull cord and the equipment is deployed in response to pulling the pull cord.

3. The storage compartment of claim 1, wherein the equipment is medical equipment, a gas mask, a tool, a portable shelter or a weapon.

4. The storage compartment of claim 1, wherein the at least one strap, sleeve, or coupling device is positioned to allow the compartment to be worn by the user.

5. The storage compartment of claim 4, wherein the compartment is a backpack, a fanny pack, a courier bag, a belt pack, or a pocket affixed to clothing.

6. The storage compartment of claim 2, wherein pulling the pull cord opens the securing device.

7. The storage compartment of claim 6, wherein the securing device comprises at least one of Velcro, a snap, a clip, a hook, a side release buckle, a spring, a magnet, and a loop inserted into a ring with the pull cord deployed through the loop.

8-9. (canceled)

10. The storage compartment of claim 4, wherein the compartment is a backpack and the door is a flap on the backpack.

11. (canceled)

12. The storage compartment of claim 10, wherein the flap further comprises
a window and configured to quickly release the gas mask through the window when the pull cord is pulled.

13. The storage compartment of claim 2, wherein the door is a first door and further comprising a second door, and wherein pulling the pull cord also opens the second door.

14. The storage compartment of claim 2, wherein the door opens only when the pull cord is pulled in a specified direction.

15. The storage compartment of claim 2, wherein the compartment is a first compartment and further comprising a second compartment and a second pull cord coupled to the second compartment, wherein the second compartment is deployed in response to pulling the second pull cord.

16. The storage compartment of claim 2, wherein the door is a first door and further comprising a second door, wherein the compartment is a first compartment and further comprising a second compartment, and wherein the first door of the first compartment opens when the pull cord is pulled in a first predetermined direction, and the second door of the second compartment opens when the pull cord is pulled in a second predetermined direction.

17. The storage compartment of claim 13, wherein the door of the first door opens when the pull cord is pulled a first distance and the second door opens when the pull cord is pulled a second distance.

18. The storage compartment of claim 2, wherein the door closes when the pull cord is released.

19-33. (canceled)

34. A storage compartment configured to house a gas mask and a gas mask equipment connected to the gas mask via a conduit, comprising:
a first compartment configured to store the gas mask prior to deployment and to release the gas mask upon deployment by a user;
a deployment device, activatable by a user, wherein upon activation of the deployment device the first compartment releases the gas mask; and
a second compartment configured to house the gas mask equipment.

35. The storage compartment of claim 34, wherein activation of the deployment devices comprises the user pulling a pull cord coupled to the first compartment or activating an electronic signal.

36-37. (canceled)

38. The storage compartment of claim 4, wherein the deployment mechanism is a pull cord, and further comprising:
a tab disposed on the at least one strap, sleeve, or coupling device, the tab having first and second sides and top and bottom faces, the bottom face having Velcro disposed thereon, the tab configured to receive the pull cord underneath the tab between the bottom face and the strap, and wherein the pull cord comprises a Velcro section of a Velcro type configured to secure to the Velcro disposed on the bottom face of the tab, and the pull cord Velcro section is configured to be received between the tab's bottom face and the at least one strap, sleeve, or coupling device so that the pull cord is precluded from being inadvertently pulled by the user or other forces.

39. The storage compartment of claim 34, wherein the first compartment and the second compartment form a single compartment.

40. The storage compartment of claim 34, wherein the second compartment further comprises an exit opening for the conduit.

41-50. (canceled)

51. The storage compartment of claim 34, further comprising:
a main compartment for the storage of articles;
a first opening for permitting passage of the pull cord into the backpack, the first opening leading into the main compartment;
a second opening for permitting passage of the pull cord out of the main compartment;
a flap coupled to and forming a portion of the first compartment; and
a securing device for engaging the pull cord and preventing the flap from opening when the pull cord is engaged with the securing device;
wherein when the pull cord is engaged with the securing device and the pull cord is pulled by the user, the securing device is configured to disengage with the pull cord and permit the flap to open and deploy a gas mask stored in the first compartment.

52-53. (canceled)

54. A method for rigging a backpack to quickly deploy a gas mask stored in the backpack and the backpack housing gas mask equipment connected to the gas mask via a conduit, comprising:
providing a backpack with a first section having an open side for storing the gas mask and a second section for storing the gas mask equipment, the first section disposed below or next to the second section when the back pack is worn by a user;
placing the gas mask equipment in the second section;
placing the gas mask connected to the gas mask equipment via a conduit into the first section;
folding flaps of the first section over the conduit and covering the open side so that the conduit protrudes from between the folds; and
inserting a pull cord into a securing device configured to prevent the folded flaps of the first section from unfolding;
wherein when the pull cord is pulled by a user while wearing the rigged backpack, the securing device is configured to permit the folded flaps to open and deploy the gas mask.

55. A backpack configured to house a gas mask and gas mask equipment connected to the gas mask via a conduit, the backpack comprising:
a first backpack section configured to house the gas mask inside the backpack;
a removable second backpack section configured to house the gas mask equipment while the gas mask is worn by the user and the gas mask equipment is operating, the second backpack section comprising:
a fastening mechanism for connecting and disconnecting the second backpack section from the first backpack section;
an exit opening for permitting connection between the gas mask equipment housed inside the second backpack section and the gas mask; and at least one strap for securing the second backpack section to the user when the second backpack section is disconnected from the first backpack section;
wherein the second backpack section is configured to permit a user to operate the gas mask on the user's face while the second backpack section and gas mask equipment is secured to the user via the strap;
wherein the backpack is configured to deploy the gas mask from the first backpack section in response to a single action by a user of the gas mask, when the gas mask is housed inside the backpack.
